(19) United States
(12) Patent Application Publication
(10) Pub. No.: US 2016/0044965 A1
(43) Pub. Date: Feb. 18, 2016

(54) ATOMIZER AND ELECTRONIC CIGARETTE

(71) Applicant: HUIZHOU KIMREE TECHNOLOGY CO., LTD, Huizhou (CN)

(72) Inventor: Qiuming LIU, Huizhou (CN)

(21) Appl. No.: 14/789,246

(22) Filed: Jul. 1, 2015

Related U.S. Application Data
(63) Continuation of application No. PCT/CN2014/084404, filed on Aug. 14, 2014.

(51) Int. Cl. A24F 47/00; H05B 1/02

(52) U.S. Cl. CPC A24F 47/008; H05B 1/0244

(57) ABSTRACT

An atomizer and an electronic cigarette are provided according to the present application. The atomizer includes an atomizing sleeve, an air pipe, a liquid storage chamber provided between the atomizing sleeve and the air pipe, a suction nozzle cover and an atomizer electrode respectively provided at two ends of the atomizing sleeve; and an atomizing assembly provided in the atomizing sleeve. The atomizer electrode includes an outer electrode, an insulating ring and an inner electrode, and the outer electrode is provided with a through hole. In the present application, the atomizing assembly can be replaced as required, and the airflow can flow into the atomizing sleeve by only providing a through hole in the outer electrode, and it is not necessary to perform an aligning process during the assembly of the atomizer, which ensures that the airflow may flow into the atomizer smoothly through the through hole.

### CROSS-REFERENCE TO RELATED APPLICATIONS

This application is a continuation of International Application No. PCT/CN2014/084404, titled “ATOMIZER AND ELECTRONIC CIGARETTE”, filed on Aug. 14, 2014, the entire disclose of which is incorporated herein by this reference.

### TECHNICAL FIELD

The present application relates to the technical field of electronic cigarettes, and particularly to an atomizer and an electronic cigarette which can effectively prevent noises and reduce the probability of a user sucking in cigarette liquid.

### BACKGROUND

The structure of an atomizer in the conventional technology is described below in conjunction with FIG. 1. As shown in FIG. 1, an electronic cigarette includes an atomizer 100 and a battery rod assembly 101 supplying power to the atomizer 100. The atomizer 100 includes an atomizing sleeve and a suction nozzle 102 fixedly connected to an end of the atomizing sleeve. The suction nozzle 102 is fixedly connected to the atomizing sleeve, and a smoke passage 103 configured to allow smoke to circulate is provided inside the atomizing sleeve, and one end of the smoke passage 103 is in communication with the suction nozzle 102. An atomizing assembly 104 for atomizing cigarette liquid to form smoke is provided inside the smoke passage 103. Since the atomizing assembly 104 is located inside the smoke passage 103, the cigarette liquid is apt to be congealed on the smoke passage 103, and the congealed cigarette liquid on the smoke passage 103 can not be cleaned up and may be easily sucked into the mouth by a user after a long term use, which may affect the user experience.

The atomizer 100 further includes an outer electrode 105 electrically connected to the atomizing assembly 104 and an inner electrode 106 inserted in the outer electrode 105. In order to allow airflow outside the atomizer 100 to flow into the atomizer 100 to drive the smoke atomized by the atomizing assembly 104 to be led to the suction nozzle 102 along the smoke passage 103, a first air hole 107 is provided on the outer electrode 105, and a second air hole 108 coaxial with the first air hole 107 is provided on the inner electrode 106 at a position corresponding to the first air hole 107, thus the first air hole 107 is in communication with the second air hole 108. The direction of the airflow of the electronic cigarette is indicated by an arrow shown in FIG. 1, that is, the airflow passes through the first air hole 107, the second air hole 108, a hollow portion of the inner electrode 106, and the smoke passage 103 in order and finally enters into the suction nozzle 102.

In assembling the electronic cigarette, in order to ensure the smooth communication of the airflow, it is necessary to ensure that the first air hole 107 and the second air hole 108 are arranged coaxially and are in communication with each other. However, it is not easy to align the first air hole 107 with the second air hole 108 in assembling, and if the first air hole 107 is not aligned with the second air hole 108, the exterior airflow can not flow into the atomizer 100 normally, thus the users can not suck in the smoke; and if the first air hole 107 is aligned with the second air hole 108 partially, a loud noise will be generated when the airflow passes through the first air hole 107 and the second air hole 108. Further, the assembly efficiency of such structure is low and the cost of production of the electronic cigarette is increased.

In addition, the atomizing assembly 104 in the atomizer 100 is a non-removable structure and easily damaged parts, thus the entire atomizing assembly 104 has to be replaced when being damaged, which increases the using cost and is not good for the promotion of products.

### SUMMARY

An atomizing assembly and an electronic cigarette are provided according to the present application, which may effectively prevent noises, reduce the probability of a user sucking cigarette liquid, and the atomizing assembly can be detached conveniently.

An atomizer includes an atomizing sleeve made of non-metallic material and being light-transmittable; an air pipe configured to allow smoke to circulate and inserted inside the atomizing sleeve with a clearance between the air pipe and the atomizing sleeve; a liquid storage chamber for storing cigarette liquid, which is provided between the atomizing sleeve and the air pipe and is isolated from an inner cavity of the air pipe; an installing groove which is provided on an outer peripheral surface of a first end of the atomizing sleeve; and a suction nozzle cover which is fixedly sleeved on the installing groove and is in interference fit with the installing groove, and an end of the air pipe close to the suction nozzle cover being in communication with an outer surface of the suction nozzle cover; an atomizer electrode which is detachably connected to the atomizing sleeve and is inserted into a second end of the atomizing sleeve; and an atomizing assembly which is provided close to the atomizer electrode and inside the atomizing sleeve and is configured to atomize the cigarette liquid in the liquid storage chamber to form smoke;
wherein, the atomizer electrode includes an outer electrode, an insulating ring inserted in the outer electrode, and an inner electrode inserted in the insulating ring, the atomizing assembly is electrically connected to the outer electrode and the inner electrode, and the atomizing assembly is accommodated in an atomizing chamber enclosed by the outer electrode, the atomizing chamber is in communication with the air pipe, the outer electrode is provided with a clamping protruding portion extending from an inner periphery wall of the outer electrode, the insulating ring is clamped in the outer electrode through the clamping protruding portion, and the inner electrode is inserted in a hollow portion of the insulating ring; and
the outer electrode is provided with a through hole, a distance between the through hole and the suction nozzle cover is less than a distance between the clamping protruding portion and the suction nozzle cover, and the through hole is configured to allow airflow to flow into the atomizing sleeve, to drive the smoke atomized by the atomizing assembly to flow into the air pipe and to discharge the cigarette liquid inside the outer electrode.

In the atomizer, the atomizing assembly includes a liquid guiding member, two fixing grooves opposite to each other are provided at an end, close to the suction nozzle cover, of the atomizing chamber enclosed by the outer electrode, each of the fixing grooves extends to an end surface and a side surface of the outer electrode, two ends of the liquid guiding member are inserted into the fixing grooves respectively, to allow the liquid guiding member to be fixedly provided in the atomizing sleeve through the fixing grooves; the liquid guiding member passes through the fixing grooves and extends into the liquid storage chamber, to allow the cigarette liquid in the liquid storage chamber to be delivered to the liquid guiding member; and an electric heating wire is wound around the liquid guiding member; and two ends of the electric heating wire are electrically connected to the outer electrode and the inner electrode respectively, to allow the electric heating wire to atomize the cigarette liquid on the liquid guiding member to form smoke.

In the atomizer, the liquid guiding member is a liquid guiding wick made of glass fiber material; and one end of the electric heating wire is inserted between the outer electrode and the insulating ring, and the other end of the electric heating wire is inserted between the inner electrode and the insulating ring.

In the atomizer, the atomizer further includes a fixing cover sleeved on an end, close to the air pipe, of the outer electrode and abutting against the liquid guiding member; and the air pipe is in communication with the fixing cover.

In the atomizer, a position-limiting protruding portion is provided on an outer surface of the outer electrode and abuts against an end surface of the fixing cover.

In the atomizer, a protrusion for supporting the liquid guiding member is provided on the outer surface of the outer electrode in a radial direction of the atomizer and close to the atomizing sleeve.

In the atomizer, the suction nozzle cover is made of metal material; an end of the air pipe close to the suction nozzle cover is configured to abut against the suction nozzle cover, or, the end of the air pipe close to the suction nozzle cover is configured to be inserted in the suction nozzle cover; and a first sealing ring is provided at a portion where the air pipe and the suction nozzle cover are connected and is configured to cover an end of the suction nozzle cover close to the atomizing assembly, and the first sealing ring is configured to seal the liquid storage chamber, to prevent the cigarette liquid stored in the liquid storage chamber from leaking.

In the atomizer, a second sealing ring is provided at a portion where the air pipe and the fixing cover are connected, and the second sealing ring is configured to isolate the liquid storage chamber from the atomizing chamber; or, a third sealing ring is provided to cover an end of the fixing cover away from the atomizing assembly, the air pipe abuts against the third sealing ring, the fixing cover is in communication with the air pipe through a hollow portion of the third sealing ring, and the air pipe, the third sealing ring and the fixing cover are successively arranged in an axial direction of the atomizer; and the third sealing ring is configured to seal the portion where the fixing cover and the air pipe are connected, to prevent the cigarette liquid stored in the liquid storage chamber from leaking into the fixing cover and the air pipe.

In the atomizer, a fourth sealing ring is provided between the atomizing sleeve and the outer electrode, and the fourth sealing ring is configured to prevent the cigarette liquid stored in the liquid storage chamber from leaking.

In the atomizer, a liquid storage member for storing cigarette liquid is provided in the liquid storage chamber; and the liquid guiding member passes through the fixing grooves and extends into the liquid storage member, to allow the cigarette liquid in the liquid storage member to be delivered to the liquid guiding member.

In the atomizer, an outer end surface of the suction nozzle cover is a spherical surface.

An electronic cigarette includes an atomizer according to any one of the above solutions and a battery rod assembly configured to supply power to the atomizer, wherein the atomizer is arranged coaxially with the battery rod assembly; the battery rod assembly includes a battery sleeve, and a battery rod electrode is provided at an end of the battery sleeve close to the atomizer and is electrically connected to the atomizer electrode, and a battery is provided in the battery sleeve and is electrically connected to the battery rod electrode.

In the electronic cigarette, the battery rod assembly further includes: an airflow sensor, which is configured to generate a trigger signal in a case that it is sensed that a user smokes through the suction nozzle cover; and a microcontroller electrically connected to the battery, and configured to control the battery to supply power to the electric heating wire according to the trigger signal.

In the electronic cigarette, the battery rod assembly further includes: a button provided on the battery sleeve and configured to receive a pressing operation of the user; and a micro switch which is connected to the button and configured to generate a control signal in response to the pressing operation, wherein the micro switch is electrically connected to the battery, to allow the battery to supply power to the electric heating wire according to the control signal.

An atomizer and an electronic cigarette are provided according to the present application. The atomizer includes an atomizing sleeve; an air pipe inserted inside the atomizing sleeve with a clearance between the air pipe and the atomizing sleeve; a liquid storage chamber for storing cigarette liquid, which is provided between the atomizing sleeve and the air pipe and is isolated from an inner cavity of the air pipe; an installing groove which is provided on an outer peripheral surface of a first end of the atomizing sleeve; and a suction nozzle cover which is fixedly sleeved on the installing groove, and an end of the air pipe close to the suction nozzle cover being in communication with an outer surface of the suction nozzle cover; an atomizer electrode which is detachably connected to the atomizing sleeve and is inserted into a second end of the atomizing sleeve; and an atomizing assembly which is provided close to the atomizer electrode and inside the atomizing sleeve. The atomizer electrode includes an outer electrode, an insulating ring and an inner electrode, the atomizing assembly is electrically connected to the outer electrode and the inner electrode, and the outer electrode is provided with a through hole, and a distance between the through hole and the suction nozzle cover is less than a distance between the clamping protruding portion and the suction nozzle cover, and the through hole is configured to allow airflow to flow into the atomizing sleeve, to drive the smoke atomized by the atomizing assembly to flow into the air pipe and to discharge the cigarette liquid inside the outer electrode. In the present application, the atomizing assembly is not provided in the smoke passage, thus it is convenient for the user to replace the atomizing assembly, and the airflow can flow into the atomizing sleeve by only providing a through hole in the outer electrode, without providing a through hole in the inner electrode, thus it is not necessary to perform an aligning process during the assembly of the atomizer. Thus, it is ensured that the airflow may flow into the atomizer smoothly through the through hole, and the airflow may flow directly into the air pipe via the atomizing chamber after passing through the through hole, thereby effectively reducing the noises generated during the operation of the atomizer. The condensed or leaked cigarette liquid accumulated in the air pipe and the atomizing chamber may be threw out via the through hole, thereby reducing the probability of a user sucking in the cigarette liquid and improving the user experience in using the electronic cigarette. In addition, the present application has a simple and compact structure and is convenient to be assembled, the suction nozzle cover sleeved on the atomizing sleeve can well avoid the issue that the suction nozzle cover may be detached from the atomizing sleeve due to elastic deformation of the suction nozzle cover caused by a clamping force on the outer wall of the atomizing sleeve applied by the mouth of the user when the suction nozzle cover is inserted in the atomizing sleeve.

### BRIEF DESCRIPTION OF THE DRAWINGS

FIG. 1 is a schematic view showing the sectional structure of an atomizer in the conventionally technology;

FIG. 2 is a schematic view showing the sectional structure of a preferred embodiment of an atomizer according to embodiments of the present application;

FIG. 3 is an exploded schematic view showing the structure of a preferred embodiment of an atomizer according to embodiments of the present application;

FIG. 4 is a schematic view showing the partial sectional structure of a preferred embodiment of an atomizer according to embodiments of the present application;

FIG. 5 is a schematic view showing the sectional structure of another preferred embodiment of an atomizer according to embodiments of the present application;

FIG. 6 is a schematic view showing the sectional structure of a preferred embodiment of an electronic cigarette according to embodiments of the present application; and

FIG. 7 is a schematic view showing the overall structure of a preferred embodiment of an outer electrode according to embodiments of the present application.

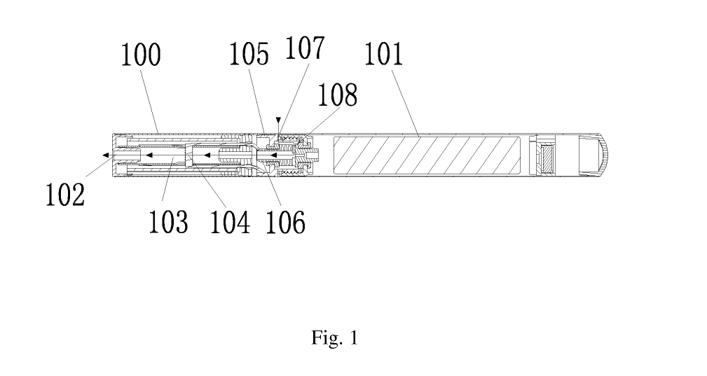

### DETAILED DESCRIPTION

In a first embodiment, the specific structure of an atomizer is described in detail in this embodiment, and the atomizer may reduce the noise generated during the use and reduce the probability of a user sucking in cigarette liquid.

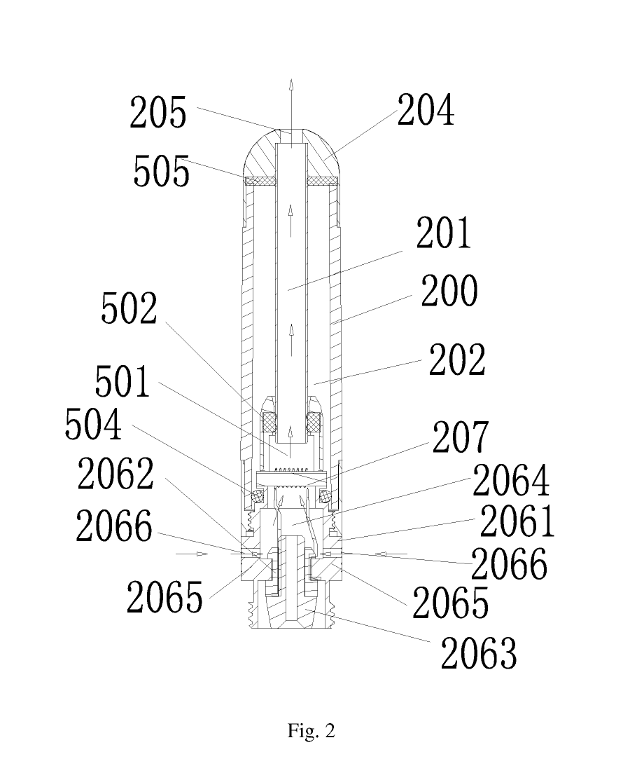

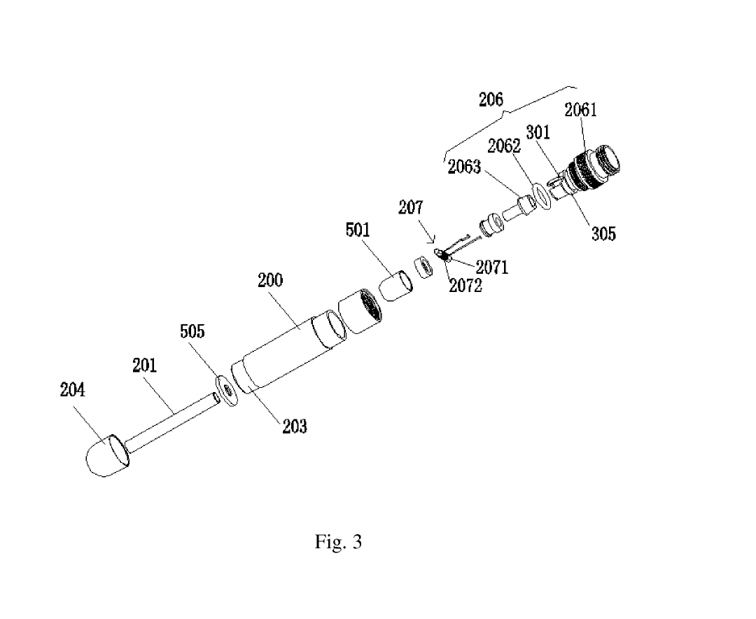

Reference is made to FIGS. 2 and 3. The atomizer includes: an atomizing sleeve 200 which is made of non-metallic material and is light-transmittable. Cigarette liquid is stored in the atomizing sleeve 200, and in order to allow users to check the remaining amount of the cigarette liquid at any time, the atomizing sleeve 200 is provided to be light-transmittable, and the specific material of the atomizing sleeve 200 is not limited in this embodiment, as long as it is light-transmittable.

Preferably, a scale may be provided on an outer surface of the atomizing sleeve 200, thus the user can determine, through the scale, how long the remaining cigarette liquid may be smoked.

An air pipe 201 configured to allow smoke to circulate is inserted in the atomizing sleeve 200 with a clearance between the air pipe and the atomizing sleeve 200.

In order to effectively prevent the smoke from being condensed to cigarette liquid due to condensation effect when passing through the air pipe 201, preferably, a heat-insulating sleeve can be inserted in the air pipe 201. The material of the heat-insulating sleeve is not limited, as long as it has heat-insulating performance, and the heat-insulating sleeve may be glass fiber material.

A liquid storage chamber 202 for storing cigarette liquid is provided between the atomizing sleeve 200 and the air pipe 201 and is isolated from an inner cavity of the air pipe 201.

In this embodiment, the storage amount of the cigarette liquid may be effectively increased by storing the cigarette liquid in the liquid storage chamber 202, which increases the duration of using the atomizer.

An installing groove 203 is provided on an outer peripheral surface of a first end of the atomizing sleeve 200. A suction nozzle cover 204 is fixedly sleeved on the installing groove 203. The suction nozzle cover 204 is in interference fit with the installing groove 203.

In assembling the atomizer, as long as a pressure is applied on the suction nozzle cover 204 to sleeve the suction nozzle cover 204 on the first end of the atomizer 200 through the installing groove 203, the suction nozzle cover 204 can be fixed on the atomizing sleeve 200 due to the interference fit between the suction nozzle cover 204 and the installing groove 203, and this structure is stable. If a user wishes to clean or replace the suction nozzle cover 204, a force making the suction nozzle cover 204 away from the atomizing sleeve 200 may be applied on the suction nozzle cover 204, to disengage the suction nozzle cover 204 from the atomizing sleeve 200.

Preferably, the material of the suction nozzle cover 204 is not limited in this embodiment. In order to ensure a smooth communication of the smoke, a through hole 205 may be provided in the suction nozzle cover 204, and further, to avoid the situation that the user cannot smoke due to blockage of the through hole, multiple through holes 205 may be provided in the suction nozzle cover 204.

Preferably, the suction nozzle cover 204 of this embodiment is made of metal material, which may avoid the situation that the suction nozzle cover 204 is apt to fall off when a hard object, such as teeth, clamps the suction nozzle cover 204. Specifically, the metal can be copper, iron or steel and other metal, which is not limited here.

In order to ensure the smooth communication of the smoke, an end of the air pipe 201 close to the suction nozzle cover 204 is in communication with the outer surface of the suction nozzle cover 204, thus the through hole 205 provided in the suction nozzle cover 204 is in communication with the air pipe 201.

An atomizer electrode 206 detachably connected to the atomizing sleeve 200 is inserted in a second end of the atomizing sleeve 200.

The manner of detachably connecting the atomizer electrode 206 to the second end of the atomizing sleeve 200 is not limited in this embodiment. For example, the second end of the atomizing sleeve 200 is provided with a threaded section, the outer periphery surface of the atomizer electrode 206 is also provided with a threaded section, and the atomizer electrode 206 may be screwed onto the end of the atomizing sleeve 200 through the threaded sections. Of course, other detachable connections may also be adopted, such as snap fit, magnet attraction and etc., and the specific manner is not limited in this embodiment.

An atomizing assembly 207 is provided inside the atomizing sleeve 200 close to the atomizer electrode 206 and is configured to atomize the cigarette liquid in the liquid storage chamber 202 into smoke.

Since the atomizing assembly 207 in this embodiment is provided outside the air pipe 201, the user may replace the atomizing assembly 207 at any time, and does not need to replace the whole atomizer.

The atomizer electrode 206 includes an outer electrode 2061, an insulating ring 2062 provided in the outer electrode 2061, and an inner electrode 2063 provided in the insulating ring 2062.

The atomizing assembly 207 is electrically connected to the outer electrode 2061 and the inner electrode 2063.

In order to arrange the atomizing assembly 207 in the atomizing sleeve 200 more stably and increase the efficiency of assembling the atomizer, the outer electrode 2061 extends in a direction towards the suction nozzle cover 204 to form an atomizing chamber 2064.

The atomizing assembly 207 is accommodated in the atomizing chamber 2064 enclosed by the outer electrode 2061.

The specific manner of arranging the atomizing assembly 207 in the atomizing chamber 2064 is not limited in this embodiment.

The atomizing chamber 2064 is in communication with the air pipe 201, to ensure the smooth communication of airflow.

The outer electrode 2061 is provided with a clamping protruding portion 2065 extending from the inner periphery wall of the outer electrode 2061. The insulating ring 2062 is clamped in the outer electrode 2061 through the clamping protruding portion 2062, and the inner electrode 2063 is inserted in a hollow portion of the insulating ring 2062.

The outer electrode 2061 is provided with a through hole 2066. The distance between the through hole 2066 and the suction nozzle cover 204 is less than the distance between the clamping protruding portion 2065 and the suction nozzle cover 204.

The through hole 2066 is used for allowing the airflow to flow into the atomizing sleeve 200 to drive the smoke atomized by the atomizing assembly 207 to flow into the air pipe 201.

In this embodiment, the airflow can flow into the atomizing sleeve 200 through the through hole 2066 provided in the outer electrode 2061, without providing a through hole in the inner electrode 2063, thus it is not necessary to align the first air hole on the outer electrode with the second air hole on the inner electrode as shown in the conventional technology during the assembly of the atomizer. In this embodiment, the inner electrode 2063 can be directly inserted in the outer electrode 2061 without alignment, thereby ensuring that the airflow may flow into the atomizer smoothly through the through hole 2066. The airflow direction is shown in FIG. 2, and the airflow flows directly into the air pipe 201 via the atomizing chamber 2064 after passing through the through hole 2066, thereby effectively reducing the noises generated during the operation of the atomizer. The condensed or leaked cigarette liquid accumulated in the air pipe 201 and the atomizing chamber 2064 may be threw out via the through hole 2066, thereby reducing the probability of a user sucking in the cigarette liquid and improving the user experience in using the electronic cigarette. In addition, the present application has a simple and compact structure and is convenient to be assembled, the suction nozzle cover 204 sleeved on the atomizing sleeve 200 can well avoid the issue that the suction nozzle cover 24 may be detached from the atomizing sleeve 200 due to elastic deformation of the suction nozzle cover 24 caused by a clamping force on the outer wall of the atomizing sleeve 200 applied by the mouth of the user when the suction nozzle cover 204 is inserted in the atomizing sleeve 200.

Preferably, the through hole 2066 is further used to discharge the cigarette liquid in the outer electrode 2061, to further prevent users from sucking in the cigarette liquid.

In a second embodiment, the structure of the atomizer is further described in detail in this embodiment.

As shown in FIG. 3, the atomizing assembly 207 includes a liquid guiding member 2071.

The specific material of the liquid guiding member 2071 is not limited in this embodiment, as long as it can absorb the cigarette liquid in the liquid storage chamber 202.

Preferably, the liquid guiding member 2071 in this embodiment is a liquid guiding wick made of glass fiber material.

A specific manner of fixedly providing the atomizing assembly 207 inside the atomizing sleeve 200 will be described in detail hereinafter.

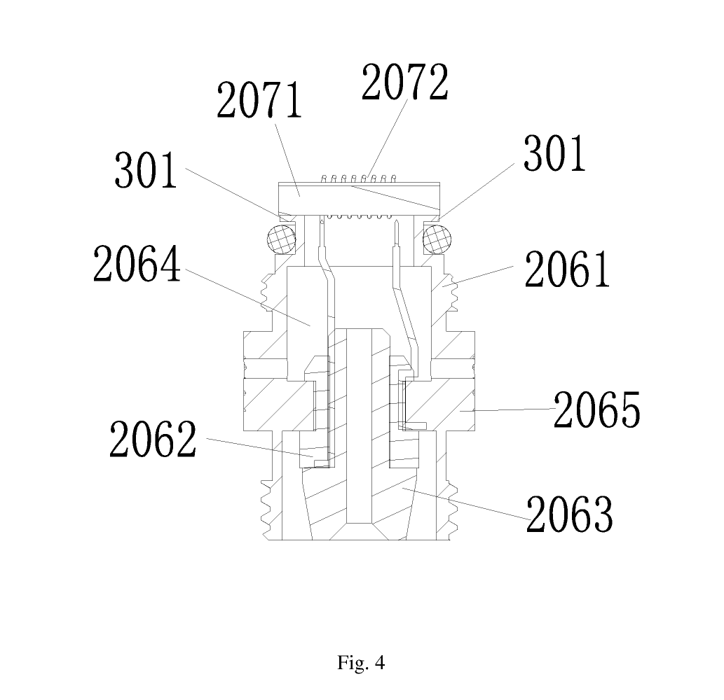

As shown in FIGS. 3 and 4, two fixing grooves 301 opposite to each other are provided on an end, close to the suction nozzle cover, of the atomizing chamber 2064 enclosed by the outer electrode 2061. The shape of the fixing grooves 301 matches with the shape of two ends of the liquid guiding member 2071, and each of the fixing grooves 301 extends to the end surface and side surface of the outer electrode 2061. Two ends of the liquid guiding member 2071 are inserted into the fixing grooves 301 respectively, thus the liquid guiding member 2071 is fixedly provided in the atomizing sleeve 200 through the fixing grooves 301.

With the fixing groove 301, it is convenient for the user to fix the liquid guiding member 2071 in the atomizing chamber 2064, and is also convenient for the user to detach the liquid guiding member 2071 from the fixing grooves 301 to replace the atomizing assembly 207.

Further, the liquid guiding member 2071 passes through the fixing grooves 301 and extends into the liquid storage chamber 202, thus the cigarette liquid in the liquid storage chamber 202 can be delivered to the liquid guiding member 2071.

An electric heating wire 2072 is wound around the liquid guiding member 2071, two ends of the electric heating wire 2072 are electrically connected to the outer electrode 2061 and the inner electrode 2063 respectively, thus the atomizer electrode 206 can supply power to the electric heating wire 2072, and further the cigarette liquid on the liquid guiding member 2071 can be atomized by the electric heating wire 2072 to form smoke.

Further, in order to facilitate assembling the atomizer, one end of the electric heating wire 2072 is inserted between the outer electrode 2061 and the insulating ring 2062, and the other end of the electric heating wire 2072 is inserted between the inner electrode 2063 and the insulating ring 2062.

In order to prevent the cigarette liquid stored in the liquid storage chamber 202 from being overly delivered to the liquid guiding member 2071, a liquid storage member for storing the cigarette liquid is provided in the liquid storage chamber 202.

The specific material of the liquid storage member is not limited in this embodiment, as long as it can store the cigarette liquid, and the material may be sponge, fiber, or composite materials of fiber mixture.

The liquid guiding member 2071 passes through the fixing grooves 301 and extends into the liquid storage member, thus the cigarette liquid in the liquid storage member can be delivered to the liquid guiding member 2071.

In order to further improve the stability of the assembled atomizer, as shown in FIGS. 2, 3 and 5, the atomizer further includes a fixing cover 501 sleeved on an end, adjacent to the air pipe 201, of the outer electrode 2061 and abutting against the liquid guiding member 2071.

With the fixing cover 501, the stability of the atomizer is further improved, and the service life of the electronic cigarette is increased.

In order to ensure the smooth communication of the airflow, the end of the air pipe 201 away from the suction nozzle cover 204 is in communication with the fixing cover 501.

Two arrangements of the position of the fixing cover 501 are described as follows.

The first arrangement is shown in FIG. 2, a second sealing ring 502 is provided at a portion where the air pipe 201 and the fixing cover 501 are connected, and the second sealing ring 502 is used for isolating the liquid storage chamber 202 from the atomizing chamber 2064.

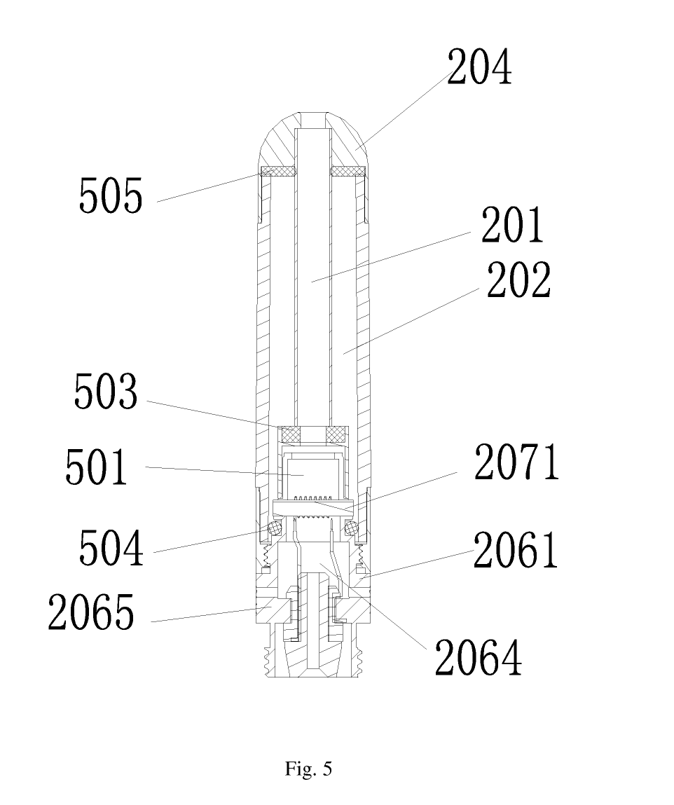

The second arrangement is shown in FIG. 5, a third sealing ring 503 is provided to cover the end of the fixing cover 501 away from the atomizing assembly 207, the air pipe 201 abuts against the third sealing ring 503, and the fixing cover 501 is in communication with the air pipe 201 through a hollow portion of the third sealing ring 503, and the air pipe 201, the third sealing ring 503 and the fixing cover 501 are successively arranged in the axial direction of the atomizer.

The third sealing ring 503 is used for sealing the portion where the fixing cover 501 and the air pipe 201 are connected, to prevent the cigarette liquid stored in the liquid storage chamber 202 from leaking into the fixing cover 501 and the air pipe 201.

In order to further prevent the cigarette liquid stored in the liquid storage chamber 202 from leaking into the outer electrode 2061, as shown in FIGS. 2 and 5, a fourth sealing ring 504 is provided between the atomizing sleeve 200 and the outer electrode 2061, and the fourth sealing ring 504 is used to prevent the cigarette liquid stored in the liquid storage chamber 202 from leaking.

Preferably, in order to avoid the liquid guiding member 2071 being squeezed excessively by the fixing cover 501, a position-limiting protruding portion is provided on the outer surface of the outer electrode 2061 and abuts against the end surface of the fixing cover 501, thus an accommodating space with a fixed size is formed between the fixing cover 501 and the outer surface of the outer electrode 2061 by providing the position-limiting protruding portion abutting against the fixing cover 501. The liquid guiding member 2071 may be located in the accommodating space, which may effectively prevent the liquid guiding member 2071 from being squeezed by the fixing cover 501, thereby effectively ensuring that the cigarette liquid stored in the liquid storage chamber 202 can be delivered to the liquid guiding member 2071 sufficiently to ensure the concentration of the smoke atomized by the electric heating wire 2072.

Preferably, as shown in FIG. 3, a protrusion 305 for supporting the liquid guiding member 2071 is provided on the outer surface of the outer electrode 2061 in the radial direction of the atomizer and close to the atomizing sleeve 200, that is, two ends of the liquid guiding member 2071 passing through the fixing grooves 301 are fixed, through the protrusion 305, at the ends of the atomizing chamber 2064 formed by the outer electrode 2061, thus the liquid guiding member 2071 located on the protrusion 305 will not slip off into the atomizing chamber 2064, thereby ensuring the service life of the atomizer.

The specific structure of the outer electrode 2061 may also referred to FIG. 7.

Further, the end of the air pipe 201 close to the suction nozzle cover 204 abuts against the suction nozzle cover 204, or the end of the air pipe 201 close to the suction nozzle cover 204 is inserted in the suction nozzle cover 204.

FIG. 2 is an example that the end of the air pipe 201 close to the suction nozzle cover 204 is inserted in the suction nozzle cover 204.

The arrangement between the air pipe 201 and the suction nozzle cover 204 is not limited in this embodiment, as long as the air pipe 201 is in communication with the suction nozzle cover 204.

Furthermore, as shown in FIGS. 2 and 5, a first sealing ring 505 is provided at the portion where the air pipe 201 and the suction nozzle cover 204 are connected, and covers the end of the suction nozzle cover 204 close to the atomizing assembly 207.

The first sealing ring 505 is used for sealing the liquid storage chamber 202, to prevent the cigarette liquid stored in the liquid storage chamber 202 from leaking, to further prevent the user from sucking in the cigarette liquid leaked from the liquid storage chamber 202.

Preferably, the outer end surface of the suction nozzle cover 204 is embodied as a spherical surface, which enables the suction nozzle cover 204 to have advantages of more artistic and easy to clean and etc.

In a third embodiment, an electronic cigarette is provided.

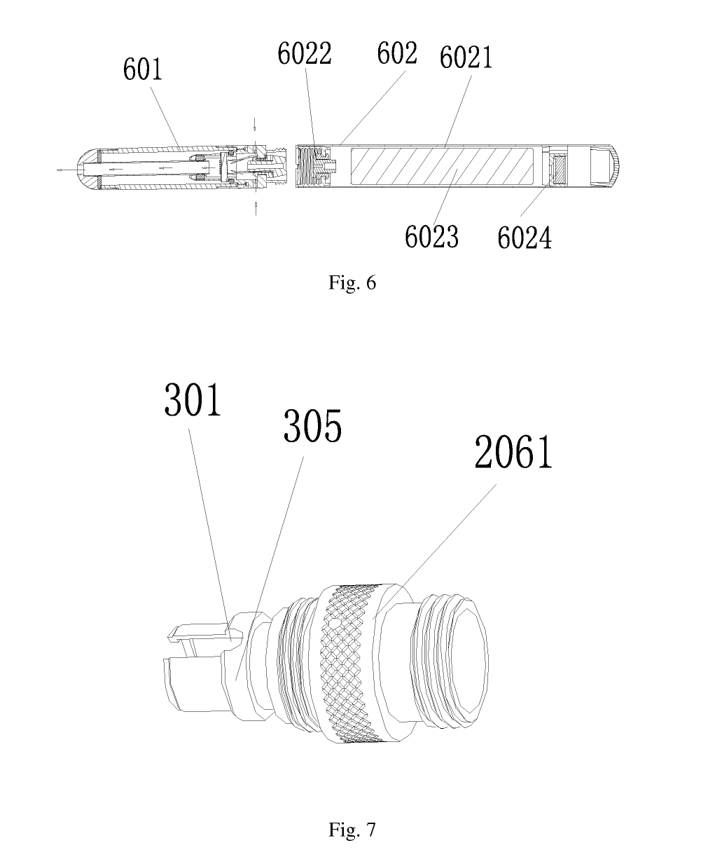

As shown in FIG. 6, the electronic cigarette according to this embodiment includes an atomizer 601 and a battery rod assembly 602 configured to supply power to the atomizer 601.

The specific structure of the atomizer 601 in this embodiment may be referred to the first embodiment and the second embodiment, and the specific structure of the atomizer 601 is not limited in this embodiment.

The atomizer 601 is arranged coaxially with the battery rod assembly 602;

The atomizer 601 and the battery rod assembly 602 in this embodiment may be fixedly provided, and may also be detachably connected.

The specific manner of the detachable connection is not limited. For example, the outer periphery wall of the outer electrode of the atomizer may be provided with a threaded section, an end of the battery rod assembly 602 close to the threaded section is provided with a threaded bushing, and threads for cooperating with the threaded section are provided inside the threaded bushing, thus the atomizer can be screwed onto the battery rod assembly 602.

The battery rod assembly 602 may include a battery sleeve 6021. An end of the battery sleeve 6021 close to the atomizer is provided with a battery rod electrode 6022 electrically connected to the atomizer electrode, and a battery 6023 electrically connected to the battery rod electrode 6022 is provided in the battery sleeve 6021.

Preferably, the battery rod assembly 602 includes an airflow sensor 6024 which is used for generating a trigger signal in a case that it is sensed that a user smokes through the suction nozzle cover. When the user sucks in the smoke through the suction nozzle cover, the air pressure inside the battery rod assembly 602 is reduced, and the airflow sensor 6024 can sense the situation that the air pressure is reduced and can generate the trigger signal accordingly.

The battery rod assembly 602 further includes a microcontroller electrically connected to the battery 6023, and the microcontroller is used for controlling the battery 6023 to supply power to the electric heating wire according to the trigger signal.

Preferably, the battery rod assembly 602 further includes a button provided on the battery sleeve and used for receiving a pressing operation of the user. The specific position of the button is not limited in this embodiment, as long as it can receive the pressing operation of the user.

A micro switch is connected to the button and configured to generate a control signal in response to the pressing operation. The micro switch is electrically connected to the battery 6023, to allow the battery 6023 to supply power to the electric heating wire according to the control signal, thus the electronic cigarette can be controlled by either of the airflow sensor 6024 and the button, which is convenient for the users to use.

It can be appreciated by those skilled in the art that, for the convenience and simplicity of the description, the specific working process of the system, the device and the unit described above may refer to the corresponding process in the method embodiment described above, and will not be repeated.

The above embodiments are only used to illustrate the technical solutions of the present application, and are not intended to limit the present application. Although the present application is described in detail with reference to the above embodiments, it can be appreciated by those skilled in the art that, the technical solutions in the various embodiments described above can be modified, or a few of the technical features of the embodiments can be replaced equivalently; and the essence of the corresponding technical solutions will not depart from the spirit and scope of the technical solutions of the various embodiments of the present application with these modifications and replacements.

1. An atomizer, comprising: an atomizing sleeve made of non-metallic material and being light-transmittable; an air pipe configured to allow smoke to circulate and inserted inside the atomizing sleeve with a clearance between the air pipe and the atomizing sleeve; a liquid storage chamber for storing cigarette liquid, which is provided between the atomizing sleeve and the air pipe and is isolated from an inner cavity of the air pipe; an installing groove which is provided on an outer peripheral surface of a first end of the atomizing sleeve; and a suction nozzle cover which is fixedly sleeved on the installing groove and is in interference fit with the installing groove, and an end of the air pipe close to the suction nozzle cover being in communication with an outer surface of the suction nozzle cover; an atomizer electrode which is detachably connected to the atomizing sleeve and is inserted into a second end of the atomizing sleeve; and an atomizing assembly which is provided close to the atomizer electrode and inside the atomizing sleeve and is configured to atomize the cigarette liquid in the liquid storage chamber to form smoke;
wherein, the atomizer electrode comprises an outer electrode, an insulating ring inserted in the outer electrode, and an inner electrode inserted in the insulating ring, the atomizing assembly is electrically connected to the outer electrode and the inner electrode, and the atomizing assembly is accommodated in an atomizing chamber enclosed by the outer electrode, the atomizing chamber is in communication with the air pipe, the outer electrode is provided with a clamping protruding portion extending from an inner periphery wall of the outer electrode, the insulating ring is clamped in the outer electrode through the clamping protruding portion, and the inner electrode is inserted in a hollow portion of the insulating ring; and
the outer electrode is provided with a through hole, a distance between the through hole and the suction nozzle cover is less than a distance between the clamping protruding portion and the suction nozzle cover, and the through hole is configured to allow airflow to flow into the atomizing sleeve, to drive the smoke atomized by the atomizing assembly to flow into the air pipe and to discharge the cigarette liquid inside the outer electrode.

2. The atomizer according to claim 1, wherein the atomizing assembly comprises a liquid guiding member, two fixing grooves opposite to each other are provided at an end, close to the suction nozzle cover, of the atomizing chamber enclosed by the outer electrode, each of the fixing grooves extends to an end surface and a side surface of the outer electrode, two ends of the liquid guiding member are inserted into the fixing grooves respectively, to allow the liquid guiding member to be fixedly provided in the atomizing sleeve through the fixing grooves;
the liquid guiding member passes through the fixing grooves and extends into the liquid storage chamber, to allow the cigarette liquid in the liquid storage chamber to be delivered to the liquid guiding member; and
an electric heating wire is wound around the liquid guiding member; and two ends of the electric heating wire are electrically connected to the outer electrode and the inner electrode respectively, to allow the electric heating wire to atomize the cigarette liquid on the liquid guiding member to form smoke.

3. The atomizer according to claim 2, wherein the liquid guiding member is a liquid guiding wick made of glass fiber material; and
one end of the electric heating wire is inserted between the outer electrode and the insulating ring, and the other end of the electric heating wire is inserted between the inner electrode and the insulating ring.

4. The atomizer according to claim 2, wherein the atomizer further comprises a fixing cover sleeved on an end, close to the air pipe, of the outer electrode and abutting against the liquid guiding member; and
the air pipe is in communication with the fixing cover.

5. The atomizer according to claim 4, wherein a position-limiting protruding portion is provided on an outer surface of the outer electrode and abuts against an end surface of the fixing cover.

6. The atomizer according to claim 3, wherein the atomizer further comprises a fixing cover sleeved on an end, close to the air pipe, of the outer electrode and abutting against the liquid guiding member; and
the air pipe is in communication with the fixing cover.

7. The atomizer according to claim 6, wherein a position-limiting protruding portion is provided on an outer surface of the outer electrode and abuts against an end surface of the fixing cover.

8. The atomizer according to claim 2, wherein a protrusion for supporting the liquid guiding member is provided on the outer surface of the outer electrode in a radial direction of the atomizer and close to the atomizing sleeve.

9. The atomizer according to claim 3, wherein a protrusion for supporting the liquid guiding member is provided on the outer surface of the outer electrode in a radial direction of the atomizer and close to the atomizing sleeve.

10. The atomizer according to claim 1, wherein the suction nozzle cover is made of metal material;
an end of the air pipe close to the suction nozzle cover is configured to abut against the suction nozzle cover, or, the end of the air pipe close to the suction nozzle cover is configured to be inserted in the suction nozzle cover; and
a first sealing ring is provided at a portion where the air pipe and the suction nozzle cover are connected and is configured to cover an end of the suction nozzle cover close to the atomizing assembly, and the first sealing ring is configured to seal the liquid storage chamber, to prevent the cigarette liquid stored in the liquid storage chamber from leaking.

11. The atomizer according to claim 4, wherein,
a second sealing ring is provided at a portion where the air pipe and the fixing cover are connected, and the second sealing ring is configured to isolate the liquid storage chamber from the atomizing chamber; or,
a third sealing ring is provided to cover an end of the fixing cover away from the atomizing assembly, the air pipe abuts against the third sealing ring, the fixing cover is in communication with the air pipe through a hollow portion of the third sealing ring, and the air pipe, the third sealing ring and the fixing cover are successively arranged in an axial direction of the atomizer; and the third sealing ring is configured to seal the portion where the fixing cover and the air pipe are connected, to prevent the cigarette liquid stored in the liquid storage chamber from leaking into the fixing cover and the air pipe.

12. The atomizer according to claim 6, wherein,
a second sealing ring is provided at a portion where the air pipe and the fixing cover are connected, and the second sealing ring is configured to isolate the liquid storage chamber from the atomizing chamber; or,
a third sealing ring is provided to cover an end of the fixing cover away from the atomizing assembly, the air pipe abuts against the third sealing ring, the fixing cover is in communication with the air pipe through a hollow portion of the third sealing ring, and the air pipe, the third sealing ring and the fixing cover are successively arranged in an axial direction of the atomizer; and the third sealing ring is configured to seal the portion where the fixing cover and the air pipe are connected, to prevent the cigarette liquid stored in the liquid storage chamber from leaking into the fixing cover and the air pipe.

13. The atomizer according to claim 1, wherein a fourth sealing ring is provided between the atomizing sleeve and the outer electrode, and the fourth sealing ring is configured to prevent the cigarette liquid stored in the liquid storage chamber from leaking.

14. The atomizer according to claim 2, wherein a liquid storage member for storing cigarette liquid is provided in the liquid storage chamber; and
the liquid guiding member passes through the fixing grooves and extends into the liquid storage member, to allow the cigarette liquid in the liquid storage member to be delivered to the liquid guiding member.

15. The atomizer according to claim 1, wherein an outer end surface of the suction nozzle cover is a spherical surface.

16. An electronic cigarette, comprising an atomizer and a battery rod assembly configured to supply power to the atomizer, wherein the atomizer is arranged coaxially with the battery rod assembly; the atomizer comprises an atomizing sleeve made of non-metallic material and being light-transmittable; an air pipe configured to allow smoke to circulate and inserted inside the atomizing sleeve with a clearance between the air pipe and the atomizing sleeve; a liquid storage chamber for storing cigarette liquid, which is provided between the atomizing sleeve and the air pipe and is isolated from an inner cavity of the air pipe; an installing groove which is provided on an outer peripheral surface of a first end of the atomizing sleeve; and a suction nozzle cover which is fixedly sleeved on the installing groove and is in interference fit with the installing groove, and an end of the air pipe close to the suction nozzle cover being in communication with an outer surface of the suction nozzle cover; an atomizer electrode which is detachably connected to the atomizing sleeve and is inserted into a second end of the atomizing sleeve; and an atomizing assembly which is provided close to the atomizer electrode and inside the atomizing sleeve and is configured to atomize the cigarette liquid in the liquid storage chamber to form smoke;
wherein, the atomizer electrode comprises an outer electrode, an insulating ring inserted in the outer electrode, and an inner electrode inserted in the insulating ring, the atomizing assembly is electrically connected to the outer electrode and the inner electrode, and the atomizing assembly is accommodated in an atomizing chamber enclosed by the outer electrode, the atomizing chamber is in communication with the air pipe, the outer electrode is provided with a clamping protruding portion extending from an inner periphery wall of the outer electrode, the insulating ring is clamped in the outer electrode through the clamping protruding portion, and the inner electrode is inserted in a hollow portion of the insulating ring; and
the outer electrode is provided with a through hole, a distance between the through hole and the suction nozzle cover is less than a distance between the clamping protruding portion and the suction nozzle cover, and the through hole is configured to allow airflow to flow into the atomizing sleeve, to drive the smoke atomized by the atomizing assembly to flow into the air pipe and to discharge the cigarette liquid inside the outer electrode; and
the battery rod assembly comprises a battery sleeve, and a battery rod electrode is provided at an end of the battery sleeve close to the atomizer and is electrically connected to the atomizer electrode, and a battery is provided in the battery sleeve and is electrically connected to the battery rod electrode.

17. The electronic cigarette according to claim 16, wherein the battery rod assembly further comprises:
an airflow sensor, which is configured to generate a trigger signal in a case that it is sensed that a user smokes through the suction nozzle cover; and
a microcontroller electrically connected to the battery, and configured to control the battery to supply power to the electric heating wire according to the trigger signal.

18. The electronic cigarette according to claim 16, wherein the battery rod assembly further comprises:
a button provided on the battery sleeve and configured to receive a pressing operation of the user; and
a micro switch which is connected to the button and configured to generate a control signal in response to the pressing operation, wherein the micro switch is electrically connected to the battery, to allow the battery to supply power to the electric heating wire according to the control signal.

19. The electronic cigarette according to claim 17, wherein the battery rod assembly further comprises:
a button provided on the battery sleeve and configured to receive a pressing operation of the user; and
a micro switch which is connected to the button and configured to generate a control signal in response to the pressing operation, wherein the micro switch is electrically connected to the battery, to allow the battery to supply power to the electric heating wire according to the control signal.
